(19) United States
(12) Patent Application Publication
(10) Pub. No.: US 2012/0128284 A1
(43) Pub. Date: May 24, 2012

(54) SLIDE BEARING, A MANUFACTURING PROCESS AND AN INTERNAL COMBUSTION ENGINE

(75) Inventor: Paulo José da Rocha Mordente, Sao Paulo (BR)

(73) Assignees: MAHLE METAL LEVE S/A, Jundiaí, Sao Paulo (BR); MAHLE INTERNATIONAL GMBH, Stuttgart (DE)

(21) Appl. No.: 13/378,830

(22) PCT Filed: Jun. 16, 2010
(86) PCT No.: PCT/EP2010/003617

§ 371 Date: Jan. 27, 2012

(30) Foreign Application Priority Data
Jun. 17, 2009 (BR) PI0903741-1

(51) Int. Cl. F16C 33/10; B05D 1/02; F16C 33/04

(52) U.S. Cl. 384/276; 427/427

(57) ABSTRACT

It is described a slide bearing, particularly to constrain at least one shaft of an internal combustion engine, having a support structure or substrate (2) to which a lining (3) is applied by a Cold Spray or Cold Gas Dynamic Spray process, the lining being comprised of at least one composite material comprising at least one alloy powder with ceramic particles and anti-seizure material.

The present invention relates to a slide bearing (crankshaft bearing, as an example) manufactured or formed by a process known as Cold Spray or Cold Gas Dynamic Spray and having a composition that increases its durability and performance.

The present invention also relates to a manufacturing process of said slide bearing and to an internal combustion (IC) engine having at least one slide bearing as described above.

### BACKGROUND OF THE INVENTION

The vast majority of IC engines, as two stroke engines and Otto/Diesel cycle four stroke engines, comprise one or more reciprocating pistons connected to a rod which converts its(their) linear moment into a rotation of a shaft called crankshaft. The linear movement of the piston is generated during the “explosion” stroke and it is converted into a rotation of the crankshaft, which is usable to move a vehicle and perform other jobs.

The operation of an IC engine is simple and well known in concept, but, due to the high loads involved, it is essential to avoid excessive radial and axial movement of the crankshaft, otherwise the durability and reliability of the engine are drastically reduced.

The components that constrain the crankshaft, avoiding its radial and axial movement, are called bearings. Additionally, some IC engines have other rotatable shafts (i.e. camshaft, balance shafts, etc.) also constrained by means of bearings.

In other words, bearing is any member having a surface which bears directly (or through a solid or liquid lubricant) against other surface having relative sliding movement. The main purpose of a bearing is to transmit a load from one surface to the other sliding surface.

Nearly all engines have a minimum of two main bearings, one at each end of the crankshaft, and they often have more one bearing than the number of crank pins. The number of main bearings is a compromise between the extra size, cost and stability of a larger number of bearings, and the compactness and light weight of a smaller number. Both have advantages in terms of performance, as a shorter and more stable crank will produce better engine balance.

During the beginning of the twenty-century, IC engines used to have a few bearings constraining the crankshaft, since these old engines did not accept well high revs (revolutions per minute) and the power generated was not outstanding. These engines, as a rule, had also a low energetic efficiency and a high fuel consumption considering the amount of power generated.

After the decade of 1960, the development of engines was focused mostly in increasing the energetic efficiency, and the resulting engines were smaller, more powerful and, as a consequence, developed their power in a much higher revs. The combination of these factors (high revs and more power developed) resulted in a high development of the bearings. Today, the tendency of making the small engines even more efficient and powerful is stronger than ever, due to the low fuel consumption with respect to the generated power, a very important task in the light of the high costs of fuel and of the global warming.

It is also important to note that a great number of IC engines use slide bearings to constrain their rotatable shafts instead of other type of bearings (i.e. rollers, etc.). Slide bearings are usually developed to operate under hydrodynamic condition but eventually, mainly during the start-up of the engine, one surface touches the other sliding surface, which produces heat and accelerates the wear of at least one of the surfaces.

Considering specifically the engines equipped with slide bearings, the crankshaft is constrained into the engine block by a series of axially spaced bearings (two, three, four, five, seven, etc.). Each slide bearing includes an upper slide bearing half seated in an arcuate recess of the block and a lower slide bearing half clamped tightly against the upper bearing half by a supportive bearing cap bolted to the engine block.

Originally, sliding surfaces were cast into a house but with technological evolvement the bearing lining was applied on a strong backing support (i.e, a steel plate). Suitable metals for lining includes lead-based, tin-based, cooper-based alloys (usually copper-lead and copper-lead-tin) and aluminum alloys (usually aluminum-tin-copper, aluminum-silicon-tin and aluminum-tin-copper-silicon alloys).

Conventionally, the manufacturing process of slide bearings includes bonding the aluminum-based alloys on steel supporting surface by making the two material strips passing together through rotating cylinders which generates a reduction in the total thickness of the two strips by mechanical deformation and consequently providing bonding strength between lining alloy and back steel.

Some alternative manufacturing processes were developed to provide a bearing surface on the supporting back steel using depositions methods classified in the thermal spray family (i.e. high velocity oxy-fuel—HVOF), wire spray and plasma spray.

Processes for the manufacturing of slide bearings are shown some prior art documents, some of them are briefly discussed below.

The patent case GB 1 083 003 refers to a HVOF process which uses a spray gun and a wire as raw material to build up bearing lining on the steel. Since the deposited material is heated up to a temperature about melting point of the raw material, part of the heated material can be deposited in semi-melted state and hence some porous and oxides are inherent of such deposition process.

The patent case GB 2 130 250 is also another example of a quite similar method called plasma spray to manufacture multilayer material having a functional layer applied on to a backing support layer. Even though the process is different from the first reference it has the same drawbacks (porous coating presenting high content of oxides).

The U.S. Pat. No. 6,416,877 claims a bearing where an aluminium-tin-copper alloy was deposited as overlay via HVOF process. It also claims others material compositions based on soft metal second phase of lead and addition of alumina up to 20% in weight. Even though HVOF process was tailored in terms of process parameters to avoid material oxidation the temperature is still high enough to partially melt material under deposition and generate some oxide content that affect the coating performance.

Another document, (patent application DF 10 2004 043 914 A1) refers to a slide bearing component coated with anti-friction metal in bronze, particularly a copper-tin alloy, copper-lead alloy, copper-aluminum alloy, tin-lead or aluminum-tin alloys. Such anti-friction materials produced by cold gas injection are applied in a hydrostatic displacement machine, particularly an axial piston machine, as half bearing, bushing or distribution disk. Such patent application intends to use the mentioned production method to replace welding method originally used to join the main part to the anti-friction metal.

All the above mentioned prior art documents reveal processes of manufacture of bearings having some inconvenient/drawback, which are not presented by the object of the present invention.

Until the present invention, there was no slide bearing having, concomitantly, the opposite properties of high scuffing and wear resistance, and also high load capacity, manufactured by the process of Cold Spray or Cold Gas Dynamic Spray.

Additionally, until the present invention, there was no manufacturing process of a slide bearing using the Cold Spray or Cold Gas Dynamic Spray to coat a composite material, giving to the resulting bearing the opposite properties of high scuffing and wear resistance.

It is an object of the present invention to provide a method of forming a plain bearing lining which will supply better performance than the current bearings, which are bimetallic.

### BRIEF DESCRIPTION OF THE INVENTION

The slide bearing of the present invention has, as its main innovative aspect, the existence of a composite lining material (the one which contacts the sliding surface of the engine shaft) deposed by Cold Spray or Cold Gas Dynamic Spray.

Such material can be applied on bimetal or trimetal bearing concepts because the main object is to improve bearing properties (load capacity, seizure and wear resistance) that are guide mainly by surface properties. Consequently a thickness of several microns is enough to improve bearing performance.

The deposition generates a layer which is after treated to form an adequate and efficient sliding bearing lining. The use of a composite material applied by Cold Spray or Cold Gas Dynamic Spray enables the obtainment of excellent properties of scuffing and wear resistance.

The composed material is made of an aluminum alloy powder with ceramic particles and anti-seizure material, all provided by mechanical blending prior to the deposition by Cold Spray or Cold Gas Dynamic Spray.

The process of manufacture of the slide bearing of the present invention has preferably the steps of obtainment of the powder mixture, preparation of the substrate, deposition of the powder mixture via Cold Spray or Cold Gas Dynamic Spray, machining and heat treatment operations.

### BRIEF DESCRIPTION OF THE DRAWINGS

FIG. 1—is a schematic view of the slide bearing object of the present invention.

FIG. 2—is a microscopic view of the balance material of a preferred embodiment of the lining of the slide bearing of the present invention.

FIG. 3—is a microscopic view of the ceramic material of a preferred embodiment of the lining of the slide bearing of the present invention.

FIG. 4—is a microscopic view of the anti-seizure material of a preferred embodiment of the lining of the slide bearing of the present invention.

FIG. 5—is a graphic presenting the scuffing property of the slide bearing of the present invention in comparison the other two baseline materials.

FIG. 6‘is a graphic presenting the wear resistance of the slide bearing of the present invention in comparison the other two baseline materials.

FIG. 7—is a graphic presenting the dynamic testing load of the slide bearing of the present invention in comparison the other two baseline materials.

FIG. 8—is a cross section of composite coating produced via cold spray method.

FIG. 9—is an etched composite coating (Ferric Chlorite) produced via cold spray method.

### DETAILED DESCRIPTION OF THE DRAWINGS

As already mentioned, the present invention relates to a new and inventive slide bearing 1,10 as well to its process of manufacture and, additionally, to an IC engine having at least one of said slide bearing.

First of all, it is important to note that the preferred embodiment of the slide bearing of the present invention is idealized to operate as a con-rod bearing, however, the concept of the invention can perfectly be used to any kind of bearing.

The slide bearings can be classified in bimetal and trimetal.

The bimetal slide bearings has a structure to which is applied a lining

On the other hand, the trimetal bearings, have additionally an intermediate layer to which the lining is applied, being an advantageous product for use in engines which operate in hard environmental conditions (in a dusty environment, for example).

In FIG. 1, the bimetal bearing is shown with the number 1 and the trimetal is shown with the number 10.

The slide bearing 1,10 object of the present invention comprises a supporting structure 2 to which is associated, by Cold Spray, a plain bearing lining 3, which is the surface that will be face to face with the other sliding surface e (i.e. the shaft of the engine).

In the case of the trimetal bearing, the lining 3 is indirectly associated to the structure 2, since it is provided the so called intermediate layer 30 between them, to which the lining 3 is in fact applied.

The specific constitution of the bearing, if bimetal or trimetal, is not relevant for the purposes of the invention, which resides in the lining 3 properties.

The supporting structure 2 (also known as substrate) is preferably made of a very strength material, as steel, carbon steel, cast iron, alloyed and micro alloyed steel, titanium and so forth, and can be made of any other material if desired. It may also include flat strip such as steel or bronze strip, pre-formed half bearing shells for the big eye of connecting rod or bore of housing block. Preferably, the supporting structure is configured as a flat strip.

As already mentioned, the Cold Spray or Cold Gas Dynamic Spraying process makes the deposition of a powder mixture over the supporting structure 2 of the bearing 1, generating a layer which, after treatment, turns the sliding bearing lining 3.

Cold spray process is a high-rate material deposition process in which small, no melted powder particles (typically 1 to 50 μm in diameter) are accelerated to very high speeds (around 600 to 1000 meters per second) in a supersonic jet of compressed gas. Upon impact with a target surface, the solid particles deform and bond together, rapidly building up a layer of deposited material.

Since the Cold Spray process does not use a high-temperature heat source (such as flame or plasma) to melt the feed material, it does not transfer large amounts of heat into a coated part. Consequently it does not degrade thermally sensitive coating materials through oxidation or other inflight chemical reactions. Mainly for this reason, the Cold Spray process is very attractive for deposition oxygen-sensitive materials.

Similarly, Cold Spray offers new possibilities for building thick coatings from nanophase materials, intermetallics or amorphous materials (which are often difficult materials to spray using conventional thermal spray techniques), since it often avoids grain growth and the formation of brittle phases. Another advantage is that residual tensile stresses associated with solidification shrinkage are eliminated.

Finally, as a last advantage, it has already been demonstrated that the ‘penning’ effect of the impinging solid particles produce beneficial compressive residual stresses in cold-spray deposited materials.

The Cold Spray process is already known and is disclosed in the U.S. Pat. No. 5,302,414, issued to Alkhimov et al.

The use of composite materials in the composition of the bearing lining 3, deposed by Cold Spray is one of the most innovative features of the present invention, giving to the bearing 1 advantageous properties of both scuffing and wear resistance.

In order to provide a composite material produced by cold spray deposition method, a composite mixture of aluminum alloyed powder (called balance material) with ceramic particles and anti-seizure material was used. Such composite material is provided by mechanical blending of the powders prior to feeding such mixture into the deposition cold spray machine, but it can be obtainable by any other method.

When compared to the current state of the art regarding bearings on bimetal materials with aluminum alloys and current bearings manufacture by the mentioned thermal spray methods, the proposed composite material applied by Cold Spray intends to supply better load capacity, improved working condition under severe lubrication regime and an ability to provide accelerated conditioning of the counterpart surface meaning reduced run in period.

According to the present invention, several combinations of different alloys can be used from the group consisting of: Al, AlCu, AlSn, AlSnSi, AlSnSiCu, Cu, CuAl, CuSn, CuSnNi, CuSnBi and CuSnBiNi, among several others. All the mentioned alloys can present a wide range of the second elements.

In order to improve surface effect by improving the lubricant effect and/or seizure resistance, other materials are required.

The improvement in the lubricant effect is obtained by adding solid lubricant, as graphite, MoS₂, BN and PTFE, among others, and a gain in the anti-seizure properties is obtained by the addition of the elements Sn, Bi or Mo, among others. Finally, adding hard particles as SiC, CBN, Al₂O₃, B₄C, Cr₃C₂, WC, Si₃N₄ and MoSi, among others, will provide an improved ability of conditioning the surface of the counterpart.

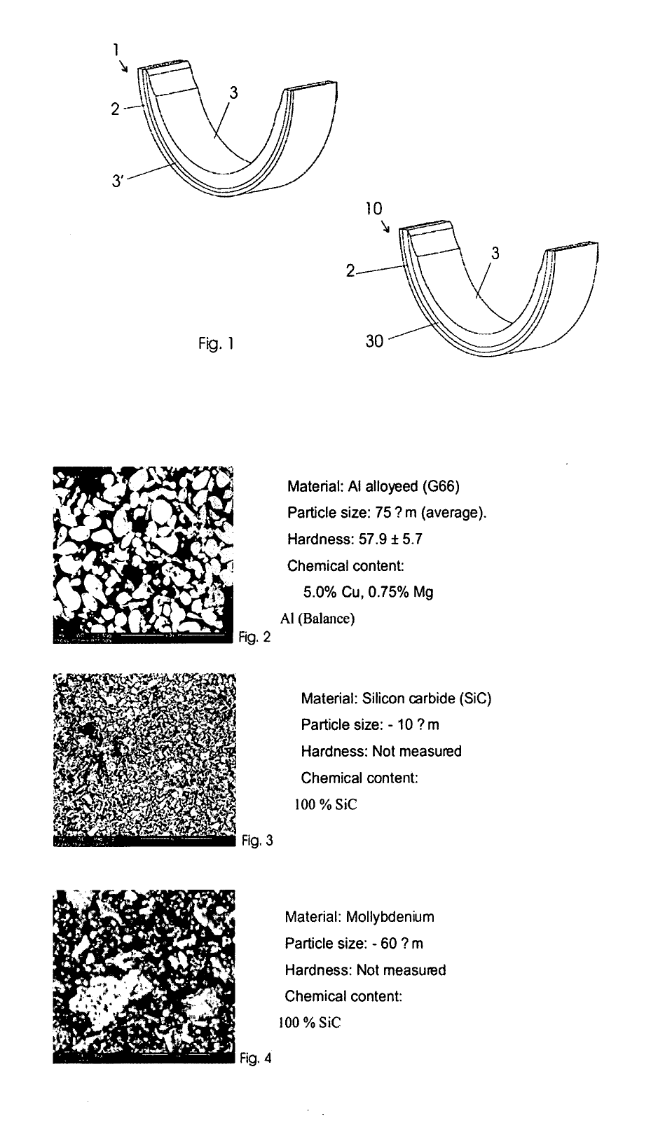

As can be seen in FIG. 2, the balance material (Al alloyed) presents quite rounded shape with grain size from 5 μm up to 100 μm, an the ceramic material (i.e. SiC, as seen in FIG. 3) is much smaller in size (from 1 μm up to 20 μm) with sharpened shape. The anti-seizure material (i.e. Mollybidenium, as seen in FIG. 4) presents a not regular shape with size ranging from 5 μm up to 300 μm.

During development of deposition process to use Cold Spray, several parameters were attempted to enhance the deposited coating concerning adhesion, cohesion and low porous content on the composite coating. See below the final process parameters defined for proper coating deposition.

TABLE I
Defined process parameter for deposition¹⁰.

| | |
|---|---|
| Gas type: | Nitrogen |
| Gas temperature: | 300° C.-550° C. |
| Gas pressure: | 22 Bar-32 Bar |

Another key feature is the preparation of the steel substrate 2 to provide proper activation of the surface to receive the composite material applied by cold spray method. It is necessary to clean the substrate 2 with solvent (i.e. acetone) to remove any oily on the surface. Moreover, free metallic surface is usually covered by relatively thin oxide layer, and such oxidation jeopardize coating adhesion so the bare steel oxidized surface must be mechanically cleaned, for instance, blasted or with sand paper. That cleaning process is responsible for surface activation to receive deposition via cold spray method.

The powder material is applied by means of a nozzle, and the relative movement between the nozzle and the substrate 2 is provided in a way the nozzle passes several times on the same substrate region, guaranteeing the correct deposition of material.

Such relative movement between the nozzle and the substrate 2 is responsible for establishing the coated area and coating thickness. Experiments showed there is no constraint related to the maximum coating thickness.

Coating application using substrate materials different from steel is also completely feasible, with its own particularities, but all approaches require chemical and mechanical cleaning to substrate activation aiming to provide good bonding strength or adhesion.

One preferred embodiment of the slide bearing 1 of the present invention comprises a lining 3 composed of an aluminum powder alloyed with 5% of cupper, 15% of silicon carbide and 15% of Mollybidenium (contents expressed in weigh).

Even though the preferred embodiment has a specific content for Mo and SiC, it is expected even 0.5% of each mentioned material will increase the performance of the mentioned bearing alloy. The upper content of each mentioned material is limited by some cracks on the deposited coating that occurs from 25% of the mentioned material.

In the case of bimetal bearings, firstly pure Al (balance material) is coated via Cold Spray with thickness about 80 μm (forming the so called bonding interlayer 3′) so the material blend of AlCu₅Mo15SiC15 is used to generate lining via Cold Spray with a thickness about 1 mm. Since the resulting surface is not smooth enough, a thickness about 150 μm is removed by machining.

After, the product is subject to a heat treatment (i.e. at 340° C. for 1 hour), to recover material deformation capacity and, subsequently, the already heat-treated material is rolled with reduction of at least 40% of the total thickness of the strip, providing a thickness suitable for submitting the strip on a regular process for bearing production.

It is important to note that the heat treatment procedure (temperature, time of submission, etc.) may vary depending upon the constitution of the bearing 1,10.

Subsequently, the strip is cut in rectangular shape in accordance with bearing diameter and length. So the produced blanks are coined and machined into the final bearing geometry.

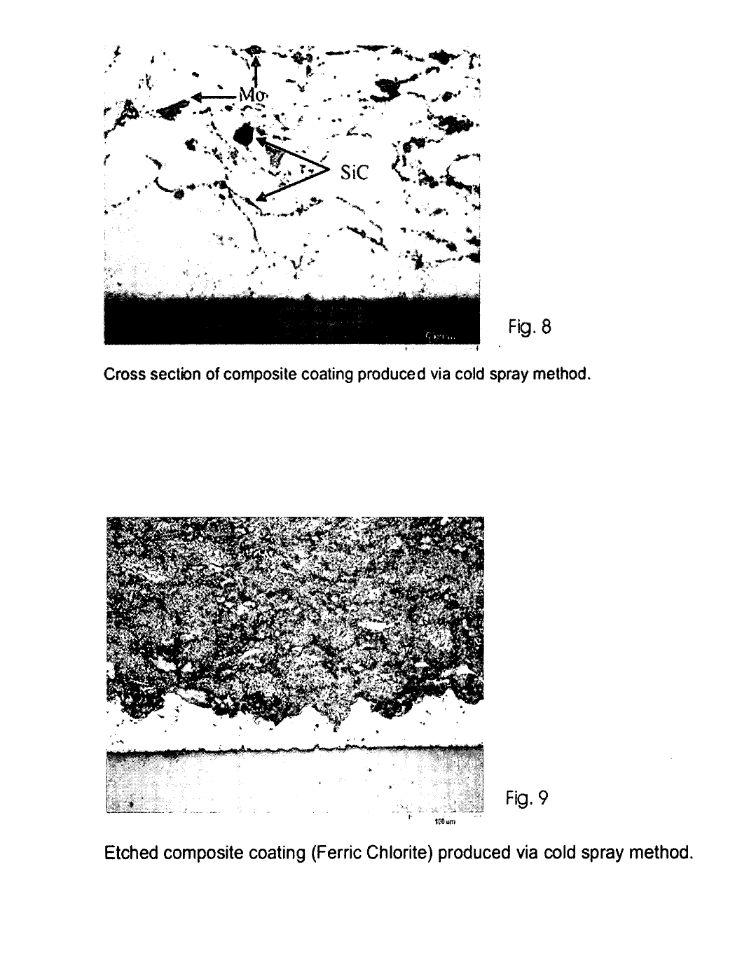

FIG. 8 presents the visual aspect of the lining material produced using the Cold Spray process, where dark regions are SiC particles and gray regions are Mo particles. In the case of bimetal bearings, the interlayer 3′ in pure Al is revealed after etching the cross section (see the white layer between steel and composite material in the FIG. 9).

The visual aspect of the composite material does not present porous that is quite common for other thermal spray processes. Furthermore the composite material produced with cold spray method present good adhesion of the deposited coating.

The produced samples for performance tests were manufactured with the following features:

Outer (housing) diameter: 56.426 mm

Bearing length: 24.485 mm

Total wall thickness: 1.786 m

Bearing alloy thickness: 0406 mm

Hardness of the produced samples: HV5=99.

The samples produced according to the above specification were tested regarding its tribologycal behavior (scuffing and wear resistance).

During the tests performed, wear and scuffing of one preferred bimetal embodiment of the slide bearing of the present invention (having a composite of AlCu₅Mo15SiC15 lining 3) was comparatively tested against bimetallic alloys of AlSn20Cu and AlSn4Si2Cu. Both rankings were obtained via simplified bench tests following internal test standards¹⁷.

For wear test it was used a standardized block on ring machine where the applied normal load and shaft speed are kept constant during all test long while the counterface is partially submerged on heated oil, so the wear is measured in terms of worn volume on a flat sample at the end of the test. The table II presents the main features for wear tests.

TABLE II
Wear test conditions.

| Test parameter | Value | Unit |
|---|---|---|
| speed | 200 | RPM |
| diameter | 37 | mm |
| material | SAE 4620 | |
| surface finishing | 0.08 to 0.12 | Ra (μm) |
| Hardness | 58-64 | HRC |
| Lubrication (Uranica C30) | | |
| temperature | 120 | ° C. |
| Viscosity | 30 | SAE |
| Normal load | 267 | N |
| Testing duration | 5,000 | Cycles |

Seizure testes were carried out on a pin-on-disk machine with controlled oil supply and increased normal load during the test up to seizure occurrence that is converted into normalized unit load (MPa). For further details about testing condition see table III below.

TABLE III
Seizure test conditions.

| Test parameter | Value | Unit |
|---|---|---|
| Disk | | |
| speed | 850 | RPM |
| diameter | 110 | mm |
| material | SAE 4340 | |
| surface finishing | 0.01 to 0.06 | Ra (μm) HRC |
| Hardness | 58-62 | |
| Lubrication (Morlina 10) | | |
| temperature | Environment | ° C. |
| viscosity | 10 | SAE |
| mass flow | 7 ± 1 | mg/min |
| Loading | | |
| increased in steps of | 44.5 | N |
| time for each level | 5 | min |
| Maximum | 1068 | N |

For both rankings, a sequence of ten tests of each material is performed aiming to generate a statistical evaluation of the material under test. The first tested material (the known bimetallic alloy AlSn20Cu) is well recognized by its good seizure resistant property due to high content of Sn, which provides good surface property under severe lubrication regime. On the other hand, the second test material (the known bimetallic alloy AlSn10Si4Cu2) presents good wear resistance property due to Si content and higher hardness when compared to the prior bearing alloy material (AlSn20Cu).

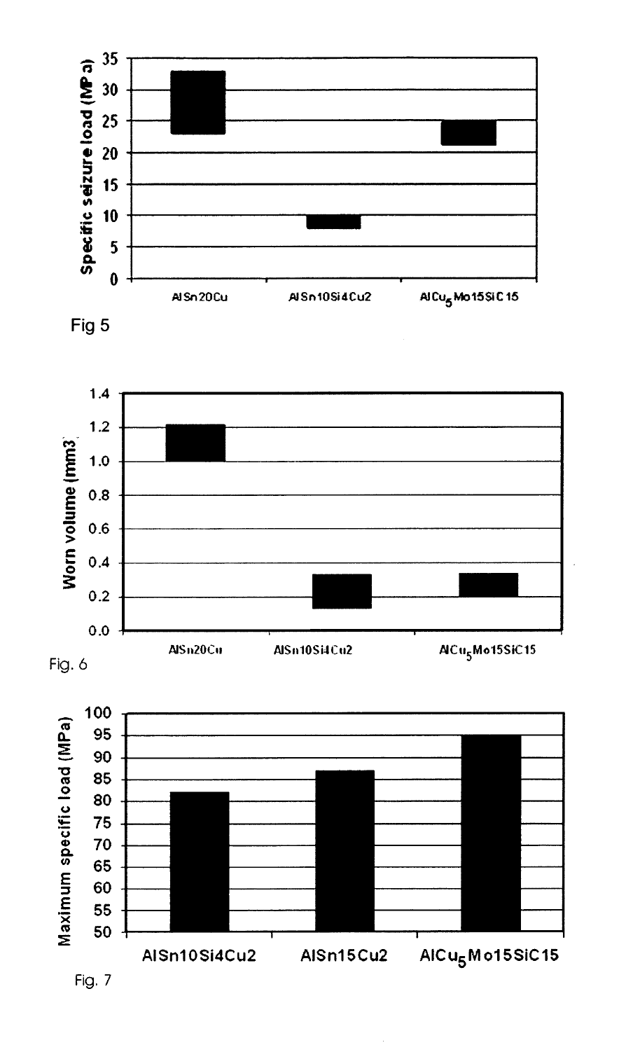

FIG. 5 presents a graphic comparing the scuffing property of the composite material used in the lining of the slide bearing of the present invention (composite of AlCu₅Mo15SiC15) in comparison the other two baseline materials.

On the vertical axis is presented the seizure resistance given in unit load (MPa). Higher unit load on a lubricated system means that oil film thickness will be reduced up to the limit of metal to metal contact. So increasing further the applied load the contact pressure increased up to a sudden failure characterized by seizure.

The results for both presented properties (wear and seizure) show a statistical treatment regarding 90% of reliability for average and any overlapping of different bars indicates that the tested population is similar. Consequently for seizure resistance the proposed composite material (AlCu₅Mo15SiC15) is statistically similar to the bimetallic material (AlSn20Cu) with high content of Sn. Also, the proposed composite material (AlCu₅Mo15SiC15) presents higher scuffing resistance than a regular bimetallic material (AlSn10Si4Cu2) showing that the proposed concept will work smoothly on the actual application concerning compatibility (scuffing resistance).

FIG. 6 shows the same three mentioned bearing materials evaluated in terms of wear resistance. The graphic shows similar wear resistance for the proposed composite coating of the slide bearing object of the present invention (AlCu₅Mo15SiC15) and the silicon content regular bimetallic known material (AlSn10Si4Cu2).

The obtained results are surprisingly on the perspective that the proposed material could supply concomitantly properties (wear and scuffing resistance) that usually are opposite because regularly bearing materials that supply good wear cannot supply good scuffing resistance, and vice versa.

Since the slide bearing object of the present invention is proposed for application on internal combustion engine, it must present suitable resistance not only for tests carried out under constant loading but the cyclic loading must be considered too.

Hence, the produced samples were submitted to fatigue test where the experiments are carried out under heated lubricated condition simultaneously to the sliding movement and sinusoidal loading. Actually the load capacity of the proposed concept is the most important feature to be validated.

The load capacity of the composite material via cold spray method is compared to the bimetallic materials with the highest load capacity. The results can be seen on the FIG. 7. The composite coating in accordance with the present invention presented an improvement about 10% on load capacity.

It is important to note that composite materials other than the (AlCu₅Mo15SiC15) can be used to form the lining of the slide bearing object of the present invention in order to achieve the desired properties of high wear and scuffing resistance, as well as greater load capacity, concomitantly. The invention, in fact, despite the preferred embodiments herein described, is related to any kind of bearing having a composite lining deposed by the Cold Spray process.

It is also an invention the manufacturing process of the present slide bearing, despite its particular constitution. In a summarized way, the manufacturing process flow for bearing production is presented below:

Step (i)—Preparation of the powder mixture.

Step (ii)—Preparation of the substrate (cleaning, etc.).

Step (iii)—Deposition of the powder mixture via cold spray method.

Step (iv)—conforming, machining and heat treatment operations.

Preferably, the step (iii) is subdivided in a step (iii.a) of deposition of an interlayer 3′ and a step (iii.b), subsequent, of deposition of the lining layer.

Still preferably, the Step (iv) is subdivided in a Step (iv.a) of heat treatment of the strip, a Step (iv.b) of rolling of the strip, a Step (iv.c) of blank production, a Step (iv.d) of coining the blank into bearing curved shape and, finally, a Step (iv.e) of finishing the bearing by machining process.

Preparation of powder mixture (Step (i)) is by preference made by mechanical blending, but evidently other solutions can be used.

The preparation of the substrate 2 (Step (ii)), as already mentioned, corresponds preferably to the cleaning of the substrate 2 with solvent (i.e. acetone) to remove any oily on the surface. It is important to note that the Step (ii) can be merely optional in case the substrate is already clean.

In the case of a bimetal bearing 1, the Step (iii.a) corresponds to the appliance, by Cold Spray, of an interlayer 3′ constituent (preferably pure Al in powder form), with a thickness preferably about 80 μm.

The Step (iii.b) corresponds to the appliance, by Cold Spray, of the powder composite AlCu₅Mo15SiC15 to form the lining layer, with a thickness preferably about 1 mm.

The Step (iv.a) corresponds to the heat treatment of the substrate (with the interlayer 3′ if applicable) and lining applied, preferably at 340° C. for 1 hour, to recover material deformation.

The Step (iv.b) corresponds to the rolling operation, for the reduction preferably of at least 40% of the total thickness of the strip.

The Step (iv.c) corresponds to the blank production, where the strip is preferably cut in rectangular shape in accordance with bearing diameter and length.

The Step (iv.d) corresponds to coining the blank into bearing curved shape (a substantially “C” shape), that is the shape of the final bearing.

Finally, the Step (iv.e) corresponds to the machining of the lining surface (which was not smooth enough before), a thickness about 150 μm being removed by machining.

Evidently, some characteristics of the manufacturing process may vary depending upon the materials used, the type and geometry of the resulting bearing, etc., and the resulting process can perfectly be included in the scope of protection of the accompanied claims.

An IC engine having at least one slide bearing according to the present invention is also a new an inventive invention, an also included in the scope of protection of the accompanied claims.

Some preferred embodiments having been described, it should be understood that the scope of the present invention embraces other possible variations, being limited only by the contents of the accompanying claims, which include the possible equivalents.

1. A slide bearing, particularly to constrain at least one shaft of an internal combustion engine, having a support structure or substrate (2) to which a lining (3) is applied by a Cold Spray or Cold Gas Dynamic Spray process, wherein the lining (3) is comprised of at least one composite material comprising at least one alloy powder with ceramic particles and anti-seizure material.

2. A slide bearing according to claim 1, wherein the composite material used is the AICu₅Mo15SiC15.

3. A slide bearing according to claim 2, wherein the lining (3) correspond to an interlayer (3′) composed of pure Al and a lining layer composed of the composite material AICu₅Mo15SiC15.

4. A slide bearing according to claim 1, wherein the substrate (2) is composed of steel or cast iron.

5. A slide bearing, particularly to constrain at least one shaft of an IC engine, having a support structure or substrate (2) to which a lining (3) is applied by a Cold Spray or Cold Gas Dynamic Spray process, wherein the lining comprises at least one of the ceramic components SIC, CBN, Al₂O₃, B₄C, Cr₃C₂, WC, Si₃N₄ or MoSi.

6. A manufacturing process of a slide bearing, wherein it comprises the following steps:
Step (i)—Preparation of the powder mixture;
Step (ii)—Preparation of the substrate (2);
Step (iii)—Deposition of the powder mixture via cold spray method; and
Step (iv)—conforming, machining and heat treatment operations.

7. A manufacturing process according to claim 6, wherein the Step (i) is made by mechanical blending, but evidently other solutions can be used.

8. A manufacturing process according to claim 6, wherein the Step (ii) corresponds preferably to the cleaning of the substrate (2) with solvent to remove any oily on the surface.

9. A manufacturing process according to claim 6, wherein the Step (iii) is subdivided in a Step (iii.a) of deposition of an interlayer (3′) and a Step (iii.b), subsequent, of deposition of the lining layer.

10. A manufacturing process according to claim 9, wherein the Step (iii.a) corresponds to the appliance, by Cold Spray, of a interlayer (3′) constituent (preferably pure Al in powder form), with a thickness about 80 μm.

11. A manufacturing process according to claim 9, wherein the Step (iii.b) corresponds to the appliance, by Cold Spray, of the powder composite AICu₅MoI5SiCI5 to form the lining layer, with a thickness preferably about 1 mm.

12. A manufacturing process according to claim 6, wherein the Step (iv) is subdivided in a Step (iv.a) of heat treatment of a strip, a Step (iv.b) of rolling of the strip, a Step (iv.c) of blank production, a Step (iv.d) of coining the blank into bearing curved shape and, finally, a Step (iv.e) of finishing the bearing by machining process.

13. A manufacturing process according to claim 12, wherein the Step (iv.a) corresponds to the heat treatment of the substrate (2) and lining applied at 340° C. for 1 hour, to recover material deformation.²²

14. A manufacturing process according to claim 12, wherein The Step (iv.b) corresponds to the rolling operation, for the reduction preferably of at least 40% of the total thickness of the strip.

15. A manufacturing process according to claim 12, wherein the Step (iv.c) corresponds to the blank production, where the strip is preferably cut in rectangular shape in accordance with bearing diameter and length.

16. A manufacturing process according to claim 12, wherein the Step (iv.d) corresponds to coining the blank into bearing curved “C” shape.

17. A manufacturing process according to claim 12, wherein the Step (iv.e) corresponds to the machining of the lining surface, a thickness about 150 μm being removed by machining.

18. An internal combustion engine, wherein it comprises at least one slide bearing (1) as defined in claim 1.
